(19) United States
(12) Patent Application Publication
(10) Pub. No.: US 2010/0123564 A1
(43) Pub. Date: May 20, 2010

(54) SELF LEARNING DATA MODULE SYSTEM

(76) Inventor: Oliver David Grunhold, Canyon Country, CA (US)

Correspondence Address: BELASCO, JACOBS & TOWNSLEY LLP;HOWARD HUGHES CENTER, 6701 CENTER DRIVE WEST, 14th Floor, LOS ANGELES, CA, 90045, US

(21) Appl. No.: 12/275,077

(22) Filed: Nov. 20, 2008

(51) Int. Cl. B60R 25/10; H04M 1/00

(52) U.S. Cl. 340/426.14; 455/556.1

(57) ABSTRACT

A self learning data module system includes a microprocessor with non-volatile memory adapted to removably attach to a vehicle equipment control network. Software extracts operational codes from the vehicle equipment control network upon activation of vehicle equipment such as door locks or arming of alarm systems. The software assigns each of the operational codes to a predetermined command codes and stores the assigned pairs in memory. An attached system with remote control is adapted to send and receive the command codes. The microprocessor transmits each of the operational codes to the network upon receipt of a command code from the attached system. Attached systems include vehicle alarms, remote starting systems, vehicle control systems, vehicle function communication systems, and cellular communications systems. The network also communicates the operational codes to the microprocessor which sends the assigned predetermined command codes to the attached system which sends command codes to the remote control.

### FIELD OF INVENTION

This invention relates to the field of automotive alarms, remote starting and accessory activation systems, and more specifically to universal data module that can be programmed to operate systems in a wide variety of automotive systems.

### BACKGROUND OF THE INVENTION

Modern automobiles employ a computerized network to access and control most automotive functions. These functions include engine management, climate control, electric windows, sunroof and tailgate operations, vehicle locking, navigation and entertainment systems, etc. These networks are typically referred to as CAN (Controller Area Network) systems. In order to add aftermarket alarms, remote starting and accessory activation systems to such CAN equipped vehicles it is necessary to connect the aftermarket products to the CAN system. As the wiring for these systems is complex and as it is desirable to maintain the wiring in an unaltered condition, the aftermarket industry has moved to the use of data modules that can be plugged into CAN systems. These modules are wireless transponders that allow communication with the CAN system through a series of code signals received from a wireless remote control.

Unfortunately, virtually every type and model of vehicle may have codes unique to that vehicle or even to the options with which that vehicle is equipped. In order to produce a data module compatible with an individual vehicle, it is necessary to research the codes used for the particular vehicle. Determining these codes is a cumbersome and difficult job, involving sophisticated equipment and techniques and results in the manufacture and stocking large numbers of data modules by aftermarket installers. The inventory of these modules must be constantly updated and the installer is forced to purchase many modules that he may never use.

Newer systems have evolved using a few variants of programmable modules for which appropriate codes can be downloaded from a server resident on the Internet. While this system severely limits the inventory of data modules that an installer must stock, it still leaves the problem of determining the vehicle model, options installed and location dependent variables that ultimately determine the codes required to operate features of a given vehicle. Attempts were made to produce data modules that would store codes for all vehicles, however, the memory requirements and cost for such modules proved to be too great for practical production of the modules. Even this system required the installer to communicate to the module the vehicle make, model and options in order to have the correct codes selected. Use of such modules resulted in many errors and proved unsatisfactory.

A variety of invention has been developed to address the problems associated with the diversity of codes and CAN systems used in modern automobiles.

U.S. Pat. No. 7,046,126, issued to Flick, discloses a vehicle window control system for a vehicle having a data communications bus may include at least one vehicle device associated with operating a window of the vehicle, a window operation transmitter, a receiver at the vehicle for receiving signals from the window operation transmitter, and a controller connected to the data communications bus for communicating with the at least one vehicle device associated with operating the window of the vehicle. The vehicle window controller may also be connected to the receiver and may be responsive to signals from the window operation transmitter. A window piggyback controller may operate the windows based on signals on the data communications bus, such as door lock or door unlock signals.

U.S. Pat. No. 5,394,327, issued to Simon, Jr. et al. is directed a transferable electronic control unit having a non-volatile memory that retains values of learned correction factors for control parameters used in adaptively controlling the operation of a vehicle is disclosed. The electronic control unit receives an identification signal from the vehicle in which it operates. By comparing the value of the received identification signal with a stored value identifying the vehicle operated when learning the values of the correction factors that are stored in non-volatile memory, the electronic control unit determines whether or not it has been transferred between vehicles. When a transfer between vehicles has not occurred, the value of the learned correction factors stored in non-volatile memory are used to begin adaptively controlling vehicle operation. When a transfer between vehicles has occurred, initial or mean values for the correction factors are used to begin adaptively controlling vehicle operation. As a result, the electronic control unit can be transferred between vehicles without causing malfunctions in vehicle operation.

U.S. Pat. No. 4,855,713, issued to Brunius illustrates a method and apparatus in a security system whereby a central processing unit self learns the identities of its distributed wireless keypad and alarm transmitters. Each transmitter includes an electrically eraseable memory containing signal conditioning data and a pseudo randomly programmed identification code. During a transmitter initiating programming condition, the CPU captures the received identification code of each transmitter and establishes an identity code table by which subsequently received transmissions are confirmed as belonging to the system. U.S. Pat. No. 5,521,588, issued to Kuhner disclose a method and apparatus for programming at least one control device in a vehicle having a plurality of control devices to be programmed, and a central control device with a non-volatile vehicle configuration memory. A bus system connects all the control devices in the vehicle to one another and to the central control device. When one of said control devices is retrofitted or replaced, it initiates a comparison of data located in its memory with the vehicle configuration data resident in the configuration memory of the central control device and, in the case of differences between these data, the data in the retrofitted or replaced control device are overwritten with current vehicle configuration data called up from the vehicle configuration memory.

U.S. Pat. No. 6,774,813, issued to Van Ec et al. is directed to a universal programmable remote is programmed for being used with a specific apparatus. A sequence of test codes is sent to the apparatus until the apparatus responds. The test codes comprise tags that are sent along. The tags fall all within a same narrow frequency band. An STB that is eavesdropping on the transmission is receptive to that band. The STB identifies the last tag and enables a server to identify the complete set of codes for the apparatus based on the tag. Thereupon the set is downloaded and programmed in the remote.

It is an objective of the present invention to provide a single data module that is simple to use, inexpensive to produce and that can be fitted to virtually all vehicles. It is a further objective to provide data modules that are accurate for any and all vehicles it which it is installed. It is a still further objective of the invention to provide data modules that would not have to have massive memory capabilities to encompass all vehicles and that could be tailored to an individual vehicle regardless of equipment or region. It is yet a further objective to provide data modules that would not require a large infrastructure to define and seek out codes for any and all vehicle at great cost in time and resources. It is still a further objective to provide data modules that would not require an external connection to the Internet for programming. Finally, it is an objective of the present invention to provide data modules that could be refitted to another vehicle when purchased.

While some of the objectives of the present invention are disclosed in the prior art, none of the inventions found include all of the requirements identified.

### SUMMARY OF THE INVENTION

The present invention addresses all of the deficiencies of self learning data module system inventions and satisfies all of the objectives described above.

(1) A self learning data module system providing all of the desired features can be constructed from the following components. A microprocessor is provided. The microprocessor is adapted to removably attach to a vehicle equipment control network. Non-volatile memory is provided. The memory is connected to the microprocessor. Software is provided. The software is adapted to extract operational codes from the vehicle equipment control network upon activation of vehicle equipment. The software assigns each of the operational codes to one of a series of predetermined command codes and stores the operational codes and assigned command codes in the memory.

(2) In a variant of the invention, the self learning data module system further includes a wireless transponder. The transponder is connected to the microprocessor and adapted to send the command codes to and receive the command codes from a wireless remote control. The microprocessor transmits each of the stored operational codes to the vehicle equipment control network upon receipt of an assigned command code from the transponder.

(3) In another variant, the self learning data module system further includes an attached system. The attached system communicates with the microprocessor and is programmed with the series of predetermined command codes. The attached system has a control for directing the attached system to communicate the predetermined command codes to the microprocessor. The microprocessor communicates each of the operational codes for which a predetermined command code has been assigned to the vehicle equipment control network upon receipt of each of the predetermined command codes.

(4) In still another variant, the vehicle equipment control network communicates the operational codes to the microprocessor, the microprocessor communicates the assigned predetermined command codes to the attached system and the attached system communicates the predetermined command codes to the control.

(5) In yet another variant, the attached system is selected from the group that includes vehicle alarms, remote starting systems, vehicle control systems, vehicle function communication systems, and cellular communications systems.

(6) In a further variant, the attached system further includes a transceiver. The transceiver is adapted to send the predetermined command codes to and receive the predetermined command codes from a cellular telephone. The cellular telephone has software adapted receive the predetermined command codes from the transceiver, to assign telephone key sequences to the command codes and to send the command codes to the transceiver upon entry of the key sequences. The attached system communicates the predetermined command codes to the microprocessor upon receipt of each of the command codes from the transceiver. The microprocessor communicates each of the operational codes for which a predetermined command code has been assigned to the vehicle equipment control network upon receipt of each of the predetermined command codes.

(7) In still a further variant, the vehicle equipment control network communicates the operational codes to the microprocessor, the microprocessor communicates the assigned predetermined command codes to the attached system, the attached system communicates the predetermined command codes to the transceiver and the transceiver communicates each of the command codes to the cellular telephone for either of storage and notification of a user.

(8) In yet a further variant, the attached system is selected from the group that includes vehicle alarms, remote starting systems, vehicle control systems, and vehicle function communication systems.

(9) In another variant of the invention, the microprocessor is serially connected to the vehicle equipment control network.

(10) In still another variant, the microprocessor is optically connected to the vehicle equipment control network.

(11) In yet another variant, the connection of the microprocessor to the vehicle equipment control network is an analog connection.

(12) In a further variant, communications between the transceiver and the cellular telephone is encrypted.

(13) In still a further variant, the self learning data module system further includes a programming switch. The programming switch either activates or deactivates a code learning function of the software. First and second indicators are provided. Both of the indicators provide a first signal upon activation of the code learning function. The first indicator provides a second signal upon activation of a selected vehicle equipment item and successful storage of an operational code associated with activation of the vehicle item. The successful storage includes assignment of each of the operational codes to one of a series of predetermined command codes. The second signal of the first indicator signals readiness for the module system to learn an operational code for activation of a subsequent vehicle equipment item. A third signal provided by the second indicator signals failure of the module system to successfully store an operational code and indicating need to reactivate the vehicle equipment item until the first indicator provides the second signal.

(14) In yet a further variant, a connection on the microprocessor allows communication of the predetermined command codes with either a security remote start or a wireless system. Each of the operational codes is transmitted from the memory to the vehicle equipment control network upon receipt of each of the predetermined command codes from either the security remote start or the wireless system.

(15) In another variant of the invention, the vehicle equipment control network communicates the operational codes to the microprocessor, the microprocessor communicates the assigned predetermined command codes to either a security remote start or a wireless system.

(16) In still another variant, the communications between the module system and either of the security remote start and the wireless system is encrypted.

(17) In yet another variant, the vehicle equipment control network is an optical network.

(18) In a further variant, the microprocessor is serially connected to the attached system.

(19) In a final variant, the microprocessor is optically connected to the attached system.

An appreciation of the other aims and objectives of the present invention and an understanding of it may be achieved by referring to the accompanying drawings and the detailed description of a preferred embodiment.

### DESCRIPTION OF THE DRAWINGS

FIG. 1 is a schematic view of the preferred embodiment of the invention illustrating the self learning data module with transponder and remote control, connected to the Controller Area Network of a vehicle;

FIG. 2 is a schematic view of a second embodiment of the invention illustrating the self learning data module in combination with an attached system and its remote control;

FIG. 3 is a schematic view of a third embodiment of the invention illustrating the self learning data module in combination with an attached system having a wireless transceiver for communication with a cell phone;

FIG. 4 is a table illustrating the assignment of operational codes to command codes stored in memory; and

FIG. 5 is a flow chart illustrating the code learning sequence of the invention.

### DETAILED DESCRIPTION OF THE PREFERRED EMBODIMENT

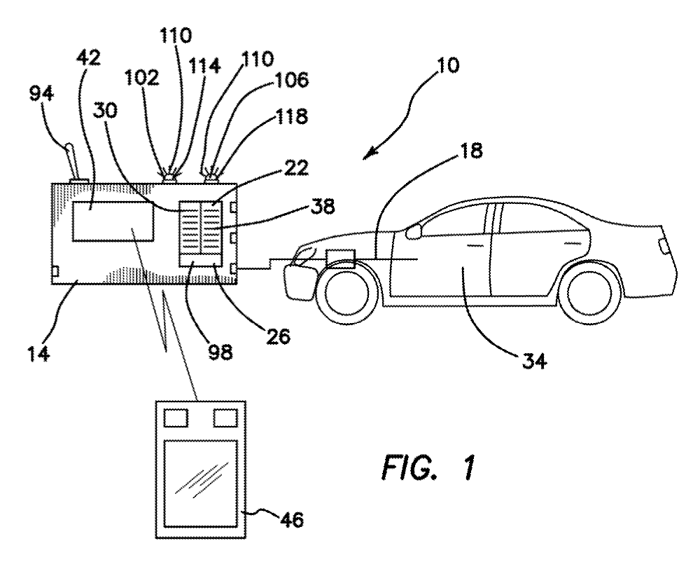

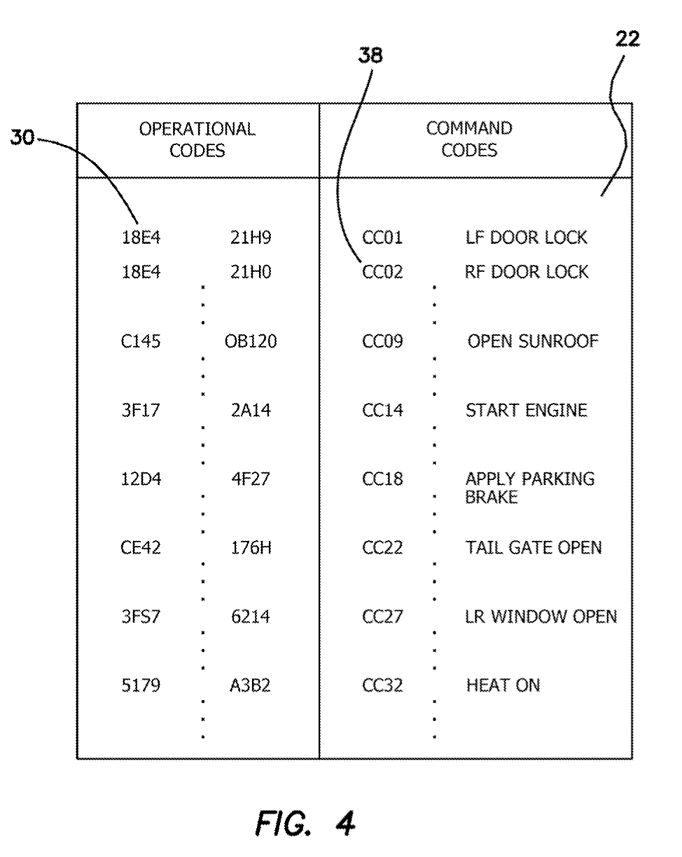

(1) FIGS. 1-5 illustrate a self learning data module system 10 providing all of the desired features that can be constructed from the following components. As illustrated in FIG. 1, a microprocessor 14 is provided. The microprocessor 14 is adapted to removably attach to a vehicle equipment control network 18. Non-volatile memory 22 is provided. The memory 22 is connected to the microprocessor 14. Software 26 is provided. The software 26 is adapted to extract operational codes 30 from the vehicle equipment control network 18 upon activation of vehicle equipment 34. The software 26 assigns each of the operational codes 30 to one of a series of predetermined command codes 38 and stores the operational codes 30 and assigned command codes 38 in the memory 22.

(2) In a variant of the invention, the self learning data module system 10 further includes a wireless transponder 42. The transponder 42 is connected to the microprocessor 14 and adapted to send the command codes 38 to and receive the command codes 38 from a wireless remote control 46. The microprocessor 14 transmits each of the stored operational codes 30 to the vehicle equipment control network 18 upon receipt of an assigned command code 38 from the transponder 42.

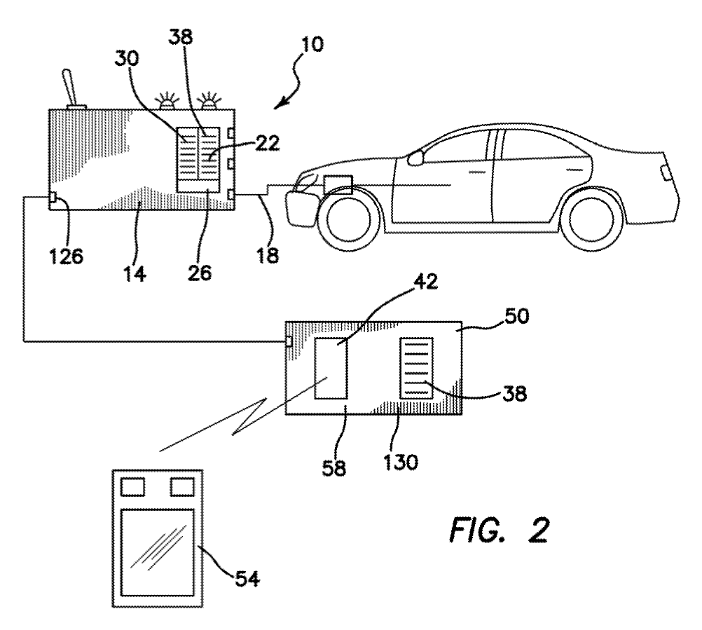

(3) In another variant, as illustrated in FIG. 2, the self learning data module system 10 further includes an attached system 50. The attached system 50 communicates with the microprocessor 14 and is programmed with the series of predetermined command codes 38. The attached system 50 has a control 54 for directing the attached system 50 to communicate the predetermined command codes 38 to the microprocessor 14. The microprocessor 14 communicates each of the operational codes 30 for which a predetermined command code 38 has been assigned to the vehicle equipment control network 18 upon receipt of each of the predetermined command codes 38.

(4) In still another variant, the vehicle equipment control network 18 communicates the operational codes 30 to the microprocessor 14, the microprocessor 14 communicates the assigned predetermined command codes 38 to the attached system 50 and the attached system 50 communicates the predetermined command codes 38 to the control 54. (5) In yet another variant, the attached system 50 is selected from the group that includes vehicle alarms 58, remote starting systems (not shown), vehicle control systems (not shown), vehicle function communication systems (not shown), and cellular communications systems (not shown).

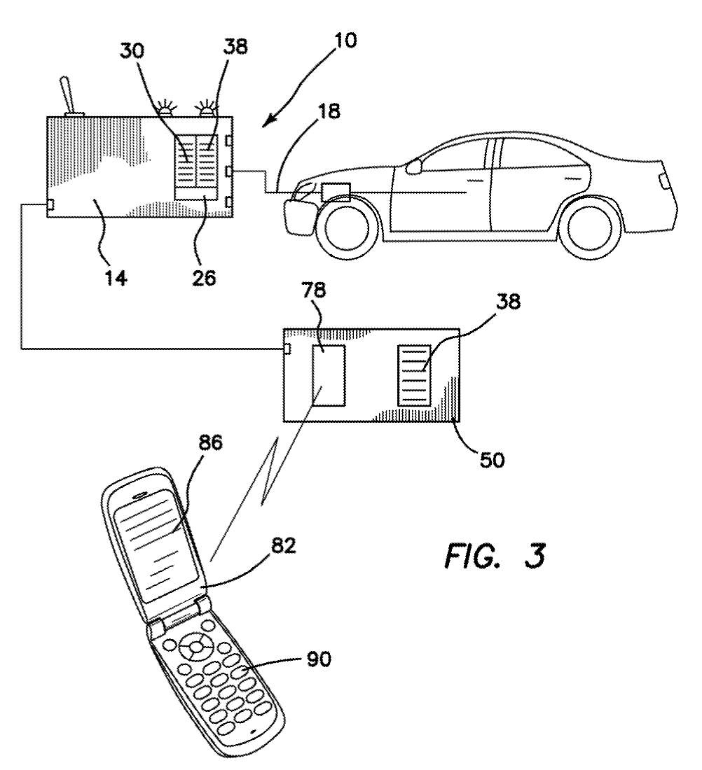

(6) In a further variant, as illustrated in FIG. 3, the attached system 50 further includes a transceiver 78. The transceiver 78 is adapted to send the predetermined command codes 38 to and receive the predetermined command codes 38 from a cellular telephone 82. The cellular telephone 82 has software 86 adapted receive the predetermined command codes 38 from the transceiver 78, to assign telephone key sequences 90 to the command codes 38 and to send the command codes 38 to the transceiver 78 upon entry of the key sequences 90. The attached system 50 communicates the predetermined command codes 38 to the microprocessor 14 upon receipt of each of the command codes 38 from the transceiver 78. The microprocessor 14 communicates each of the operational codes 30 for which a predetermined command code 38 has been assigned to the vehicle equipment control network 18 upon receipt of each of the predetermined command codes 38.

(7) In still a further variant, the vehicle equipment control network 18 communicates the operational codes 30 to the microprocessor 14, the microprocessor 14 communicates the assigned predetermined command codes 38 to the attached system 50, the attached system 50 communicates the predetermined command codes 38 to the transceiver 78 and the transceiver 78 communicates each of the command codes 38 to the cellular telephone 82 for either of storage and notification of a user (not shown).

(8) In yet a further variant, the attached system 50 is selected from the group that includes vehicle alarms 58, remote starting systems (not shown), vehicle control systems (not shown), and vehicle function communication systems (not shown).

(9) In another variant of the invention, the microprocessor 14 is serially connected to the vehicle equipment control network 18.

(10) In still another variant, the microprocessor 14 is optically connected to the vehicle equipment control network 18.

(11) In yet another variant, the connection of the microprocessor 14 to the vehicle equipment control network 18 is an analog connection.

(12) In a further variant, communications between the transceiver 78 and the cellular telephone 82 is encrypted.

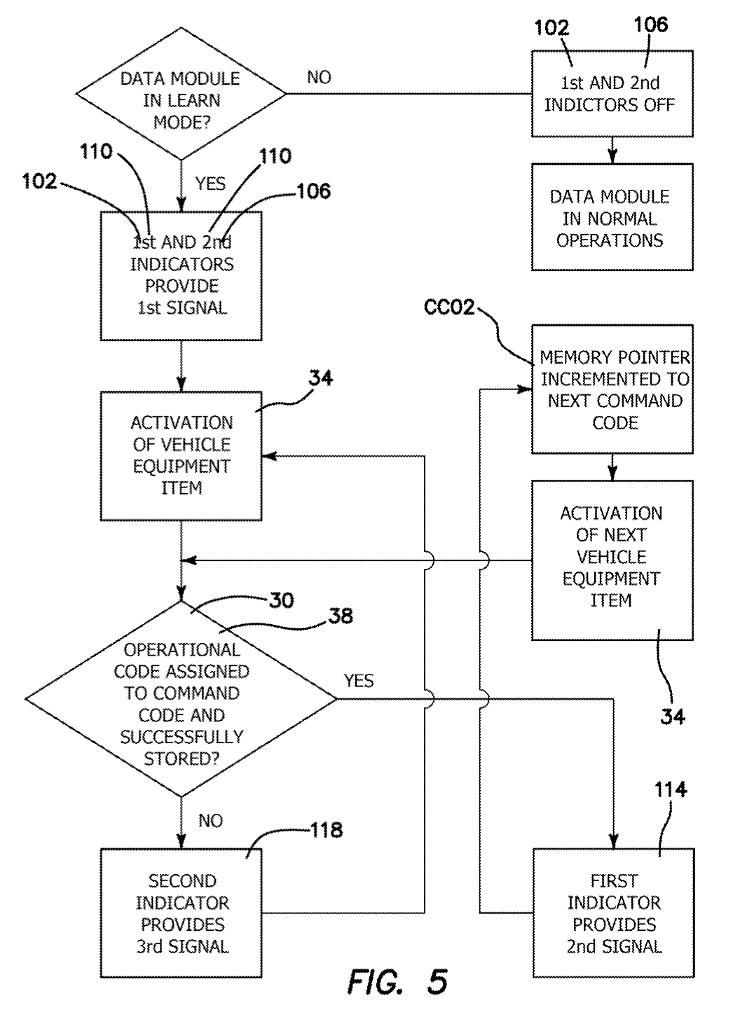

(13) In still a further variant, as illustrated in FIGS. 1 and 5, the self learning data module system 10 further includes a programming switch 94. The programming switch 94 either activates or deactivates a code learning function 98 of the software 26. First 102 and second 106 indicators are provided. Both of the indicators 102, 106 provide a first signal 110 upon activation of the code learning function 98. The first indicator 102 provides a second signal 114 upon activation of a selected vehicle equipment item 34 and successful storage of an operational code 30 associated with activation of the vehicle item 34. The successful storage includes assignment of each of the operational codes 30 to one of a series of predetermined command codes 38. The second signal 114 of the first indicator 102 signals readiness for the module system 10 to learn an operational code 30 for activation of a subsequent vehicle equipment item 34. A third signal 118 provided by the second indicator 106 signals failure of the module system 10 to successfully store an operational code 30 and indicating need to reactivate the vehicle equipment item 34 until the first indicator 102 provides the second signal 114.

(14) In yet a further variant, as illustrated in FIG. 2, a connection 126 on the microprocessor 14 allows communication of the predetermined command codes 38 with either a security remote start 130 or a wireless system (not shown). Each of the operational codes 30 is transmitted from the memory 22 to the vehicle equipment control network 18 upon receipt of each of the predetermined command codes 38 from either the security remote start 130 or the wireless system.

(15) In another variant of the invention, the vehicle equipment control network 18 communicates the operational codes 30 to the microprocessor 14, the microprocessor 14 communicates the assigned predetermined command codes 38 to either a security remote start 130 or a wireless system.

(16) In still another variant, the communications between the module system 10 and either of the security remote start 130 and the wireless system is encrypted.

(17) In yet another variant, the vehicle equipment control network 18 is an optical network.

(18) In a further variant, the microprocessor 14 is serially connected to the attached system 50.

(19) In a final variant, the microprocessor 14 is optically connected to the attached system.

The self leaning data module system 10 has been described with reference to particular embodiments. Other modifications and enhancements can be made without departing from the spirit and scope of the claims that follow.

1. A self learning data module system, comprising:
a microprocessor; adapted to removably attach to a vehicle equipment control network;
non-volatile memory, said memory connected to said microprocessor; and
software; said software adapted to extract operational codes from said vehicle equipment control network upon activation of vehicle equipment, assign each of said operational codes to one of a series of predetermined command codes and store said operational codes and assigned command codes in said memory.

2. The self learning data module system as described in claim 1, further comprising:
a wireless transponder, said transponder being connected to said microprocessor and adapted to send said command codes to and receive said command codes from a wireless remote control; and
said microprocessor transmitting each of said stored operational codes to said vehicle equipment control network upon receipt of an assigned command code from said transponder.

3. The self learning data module system as described in claim 1, further comprising:
an attached system, said attached system communicating with said microprocessor and being programmed with said series of predetermined command codes;
said attached system having a control for directing said attached system to communicate said predetermined command codes to said microprocessor; and
said microprocessor communicating each of said operational codes for which a predetermined command code has been assigned to said vehicle equipment control network upon receipt of each of said predetermined command codes.

4. The self learning data module system as described in claim 3, wherein, said vehicle equipment control network communicates said operational codes to said microprocessor, said microprocessor communicates said assigned predetermined command codes to said attached system and said attached system communicates said predetermined command codes to said control.

5. The self learning data module system, as described in claim 3, wherein said attached system is selected from the group comprising:
vehicle alarms, remote starting systems, vehicle control systems, vehicle function communication systems, and cellular communications systems.

6. The self learning data module system, as described in claim 3, wherein:
said attached system further comprises a transceiver, said transceiver adapted to send said predetermined command codes to and receive said predetermined command codes from a cellular telephone;
said cellular telephone having software adapted receive said predetermined command codes from said transceiver, to assign telephone key sequences to said command codes and to send said command codes to said transceiver upon entry of said key sequences;
said attached system communicating said predetermined command codes to said microprocessor upon receipt of each of said command codes from said transceiver;
said microprocessor communicating each of said operational codes for which a predetermined command code has been assigned to said vehicle equipment control network upon receipt of each of said predetermined command codes.

7. The self learning data module system as described in claim 6, wherein, said vehicle equipment control network communicates said operational codes to said microprocessor, said microprocessor communicates said assigned predetermined command codes to said attached system, said attached system communicates said predetermined command codes to said transceiver and said transceiver communicates each of said command codes to said cellular telephone for either of storage and notification of a user.

8. The self learning data module system, as described in claim 6, wherein said attached system is selected from the group comprising:
vehicle alarms, remote starting systems, vehicle control systems, and vehicle function communication systems.

9. The self learning data module system, as described in claim 1, wherein said microprocessor is serially connected to said vehicle equipment control network.

10. The self learning data module system, as described in claim 1, wherein said microprocessor is optically connected to said vehicle equipment control network.

11. The self learning data module system, as described in claim 1, wherein the connection of said microprocessor to said vehicle equipment control network is an analog connection.

12. The self learning data module system, as described in claim 6, wherein communications between said transceiver and said cellular telephone is encrypted.

13. The self learning data module system, as described in claims 1, further comprising:
a programming switch, said programming switch either of activating and deactivating a code learning function of said software;
first and second indicators, both of said indicators providing a first signal upon activation of said code learning function;
said first indicator providing a second signal upon activation of a selected vehicle equipment item and successful storage of an operational code associated with activation of said vehicle item;
said successful storage including assignment of each of said operational codes to one of a series of predetermined command codes;
said second signal of said first indicator signaling readiness for said module system to learn an operational code for activation of a subsequent vehicle equipment item; and
a third signal provided by said second indicator signaling failure of said module system to successfully store an operational code and indicating need to reactivate said vehicle equipment item until said first indicator provides said second signal.

14. The self learning data module system, as described in claim 1, further comprising:
a connection on said microprocessor to allow communication of said predetermined command codes with either of a security remote start and a wireless system; and
each of said operational codes transmitted from said memory to said vehicle equipment control network upon receipt of each of said predetermined command codes from either of said security remote start and said wireless system.

15. The self learning data module system, as described in claim 14, wherein said vehicle equipment control network communicates said operational codes to said microprocessor, said microprocessor communicates said assigned predetermined command codes to either of a security remote start and a wireless system.

16. The self learning data module system, as described in claim 14, wherein said communications between said module system and either of said security remote start and said wireless system is encrypted.

17. The self learning data module system, as described in claims 1, in which said vehicle equipment control network is an optical network.

18. The self learning data module system, as described in claim 3, in which said microprocessor is serially connected to said attached system.

19. The self learning data module system, as described in claims 3, in which said microprocessor is optically connected to said attached system.
